(19) United States
(12) Patent Application Publication
(10) Pub. No.: US 2018/0033223 A1
(43) Pub. Date: Feb. 1, 2018

(54) Sensor Apparatus for a Vehicle, Vehicle, Method for Operating a Sensor Apparatus

(71) Applicant: Robert Bosch GmbH, Stuttgart (DE)

(72) Inventor: Nikolaos Gortsas, Sindelfingen (DE)

(21) Appl. No.: 15/661,083

(22) Filed: Jul. 27, 2017

(30) Foreign Application Priority Data
Jul. 28, 2016 (DE) 10 2016 213 913.4

(51) Int. Cl. G07C 5/08; G01J 1/02; G01P 21/00

(52) U.S. Cl. CPC G07C 5/0808; G01P 21/00; G01J 1/0228; G07C 5/008

(57) ABSTRACT

The disclosure relates to a sensor apparatus for a vehicle, in particular a motor vehicle, having at least one sensor for detecting operational values of the vehicle while driving on a roadway, having a checking device for monitoring the functional capability of the at least one sensor. There is provision that the checking device has at least one communication device which is designed to detect a reference means in the surroundings of the vehicle during driving, and a control unit which compares an output signal of the sensor with an expected setpoint output signal as a function of a detected reference means, in order to determine the functional capability of the sensor.

This application claims priority under 35 U.S.C. §119 to application no. DE 10 2016 213 913.4, filed on Jul. 28, 2016 in Germany, the disclosure of which is incorporated herein by reference in its entirety.

### BACKGROUND

The disclosure relates to a sensor apparatus for a vehicle, in particular motor vehicle, having at least one sensor for detecting operational values of the vehicle while driving on a roadway, and having a checking device for monitoring the functional capability of the at least one sensor.

The disclosure also relates to a vehicle having such a sensor apparatus and to a method for operating same.

Sensor apparatuses, vehicles and methods for operating such sensor apparatuses are already known from the prior art. Modern vehicles are now equipped with a multiplicity of sensors which monitor a wide variety of operational values and functions of the vehicle and values relating to the surroundings of the vehicle while driving, that is to say during travel, in order to operate driving safety systems, such as, for example, an ESP, ABS, TCS (traction control system) or restraint systems, or in order to permit an engine control system, damping control system or other driving needs. In particular with respect to the intended autonomous driving, it is to be assumed that the number of sensors in the vehicle will increase further. In particular with respect to the autonomous driving, the functional capability of such sensors plays a significant role here. Fault-free sensors are necessary to correctly display and execute the abovementioned functions. Depending on the function, defective or faulty sensors can limit the driving experience or the driving safety. It is therefore important to detect faulty sensors or faults in sensors early. It is therefore possible to place a faulty sensor or a system operating using the sensor in a safe state. This state can be, for example, the activation of a warning light and/or the deactivation or limitation of a function.

Rapid identification of faulty sensors is necessary. However, this must not lead to a situation in which temporary disruptions, for example owing to external influences, give rise to premature fault identification and system deactivation. Different methods for detecting faults in sensors are already known, said methods being carried out either by the sensor itself or by a control unit which evaluates the data of the sensor. The known methods have in common the fact that they wish to identify the functional capability of the sensor either during the initialization of the control unit or during normal driving without detecting the current driving state. Therefore, known methods for fault detection are operated in such a way that the probability of fault detection on the basis of temporary influences is low. However, as a result the identification depth is also reduced. Therefore, only fault patterns which are present over a relatively long time and are directed are usually identified. Until now, this has been the only way in which a sensor fault can be reliably differentiated from temporary disruption of sensors.

### SUMMARY

The sensor apparatus according to the disclosure having the features of the disclosure has the advantage that data relating to the current driving situation or the current driving state of the vehicle is detected or determined, with the result that, in particular, external influences on the sensor which occur only temporarily do not lead to a situation in which a malfunction of the sensor is incorrectly detected. According to the disclosure, for this purpose there is provision that the checking device has at least one communication device which is designed to detect at least one reference means in the surroundings of the vehicle during driving, and a control unit which compares an output signal of the sensor with an expected setpoint output signal as a function of a detected reference means, in order to determine the functional capability of the sensor.

The checking device is therefore used to carry out communication with the surroundings of the vehicle, by means of which communication the functional capability of the sensor is determined. For this purpose, the communication device is designed to detect one or more reference means in the surroundings of the vehicle. In particular, when a first reference means is detected the communication device detects the start of a reference section, and when a second subsequent reference means is detected the end of the reference section is detected. Within this reference section comparison of the output signal with the setpoint output signal of the sensor is preferably carried out. The reference means may be, for example, visual marks which mark, for example, the entry and exit of a tunnel or the start and the end of a straight section of freeway. Through the detection of a reference means the communication device can also determine the start of a reference section which defines a predetermined time or a predetermined distance as a reference section, without a second reference means being necessary to characterize the end. By virtue of knowledge of the reference section or by taking into account predetermined reference means it becomes possible for a setpoint behavior of the sensor within the reference section to be compared with its actual behavior. Taking into account reference means from the surroundings of the vehicle therefore makes it possible to obtain information about the current driving state of the vehicle while driving. A setpoint output signal of the sensor, which is suitable for the reference section characterized by the reference means, is preferably determined as a function of the detected reference means, for example, from a characteristic diagram and compared with the actual output signal of the sensor, in order to identify whether the output signal behaves as expected. If this is not the case, it is possible, as already described above, to initiate a warning signal or some other safety measure. The comparison takes place, in particular, by virtue of the fact that a threshold value or a triggering threshold which would have to be exceeded by the output signal of the sensor during normal operation in order to identify a fault, is adapted to the setpoint output signal or reduced, with the result that even a small error in the output signal can be detected. As a result of the fact that the threshold value is adapted to the setpoint output signal for the purpose of checking, a narrow tolerance range is assigned to said output signal, within which range the output signal of the sensor can be located without a fault being identified. In this context, in this respect a comparison of the output signal with the setpoint output signal takes place by means of the checking threshold value which is lowered or reduced and adapted to the setpoint output signal. Finally, the threshold value for error identification during normal operation is therefore lowered to a reduced value which is adapted to the setpoint output signal, with the result that the sensor or the sensor evaluation is more sensitive while the reference section is being travelled along.

According to one preferred embodiment of the disclosure there is provision that the communication device has at least one camera device for optically detecting a visual mark as a reference means in the surroundings of the vehicle. Therefore, for example road signs or separate reference marks at the edge of the roadway can be detected as visual marks by the camera device and identified as reference means. By means of the camera device it is also possible to identify, for example, the start and the end of travel through a tunnel in an easy way by means of corresponding image evaluation algorithms, and therefore a reference section can be determined. The visual marks are particularly preferably designed to characterize the start or the end of a reference section, with the result that unambiguous assignment of the detected reference means by the communication device is possible.

Alternatively or additionally, the communication device has at least one radio module, in particular WLAN module or GSM module, for wireless communication with a stationary communication device as a reference means. Embodying the communication device as a radio module makes it possible, in particular, also to perform two-way communication between the vehicle or the sensor apparatus and the fixed reference means, as a result of which, for example, data can also be transmitted on a vehicle-specific basis, such as, for example, a set point output signal which is expected for the following route section, which in this respect forms the reference section, for one of the sensors of the sensor apparatus of the vehicle. In this case, the communication device can interrogate the comparison data, required for the reference section, from the fixed communication device.

According to a further embodiment of the disclosure there is provision that the communication device has at least one magnetosensitive sensor which interacts with at least one magnetic and/or electrical marking as a reference means in the surroundings of the vehicle. There is therefore provision, for example, that for the sensor apparatus magnetic or electrical markings are arranged on or in the roadway, which marks can be detected inductively by the communication device when the vehicle is moved over the markings. As a result, simple identification of the start and/or the end of a reference section is ensured.

The vehicle according to the disclosure having the features of one embodiment is distinguished by the sensor apparatus according to the disclosure. In this context, the already mentioned advantages are obtained. Further advantages and preferred features and combinations of features arise, in particular, from what is described above.

The method according to the disclosure having the features of one embodiment is distinguished by virtue of the fact that an output signal of the sensor is compared with an expected setpoint output signal as a function of at least one reference means located in the surroundings of the vehicle, in order to determine the functional capability of the sensor. This provides the advantages already mentioned. In particular, the expected setpoint output signal is selected as a function of the detected reference means. In this context, the setpoint output signal is selected, in particular, from a characteristic diagram or is transmitted by radio to the vehicle from the reference means. If the output signal of the sensor differs from the expected setpoint output signal by more than a predefinable value, in particular by more than the specified checking threshold value, or if the output signal is outside the tolerance range with respect to the setpoint output signal, it is therefore identified that the sensor is faulty or defective. The comparison is carried out in particular for a predefined time period or predefinable distance during the detection of a first reference means, and is then automatically ended.

According to one preferred development of the disclosure there is provision that the surroundings of the vehicle are monitored for reference means by at least one camera device, at least one radio module and/or at least one magnetosensitive sensor module. The advantages already mentioned arise here.

Furthermore there is preferably provision that the comparison is started when a first reference means is detected, and is ended when a subsequent reference means is detected. As a result, the reference section or start and end of the reference section within which the comparison of the output signal with the setpoint output signal takes place is defined by the reference means.

During the comparison the sensitivity of the sensor is preferably increased in order to obtain a more precise result during the checking. The control unit continues to carry out all other functions during this time without adverse effect. The increase in the sensitivity can be achieved by simply increasing an operating current of the sensor or by the specified changing of the threshold value in order to trigger faults. As soon as the reference section has been passed through, the sensitivity of the sensor is preferably switched to a robust setting again in order to avoid incorrect signaling by the sensor. According to a further preferred embodiment, the increasing of the sensitivity takes place independently of the knowledge of a setpoint output signal. The set point output signal must in this respect not be known to the checking device as long as a checking threshold value which is adapted to the setpoint output signal can be obtained, with the result that ultimately the comparison with the setpoint output signal can also take place by this means. By reducing the threshold value it is ensured that a large class of sensor faults can be detected in a short time while driving along the reference section, which faults would not be detected during normal operation owing to the comparatively high threshold value, wherein during normal operation the threshold value is higher in order to avoid premature fault detection which could take place owing to external influences.

According to one preferred development of the disclosure, there is also provision that a visual mark, a stationary communication device and/or a magnetic, also electromagnetic, or electrical marking are/is detected on or next to the roadway. This results in the advantages already mentioned.

### BRIEF DESCRIPTION OF THE DRAWINGS

Further advantages and preferred features and combinations of features arise, in particular, from what has been described above. The disclosure will be explained in more detail below on the basis of the drawing, in which:

FIG. 1 shows a vehicle with an advantageous sensor apparatus on a roadway in a simplified illustration, and

FIG. 2 shows a diagram explaining a method for operating the sensor apparatus.

### DETAILED DESCRIPTION

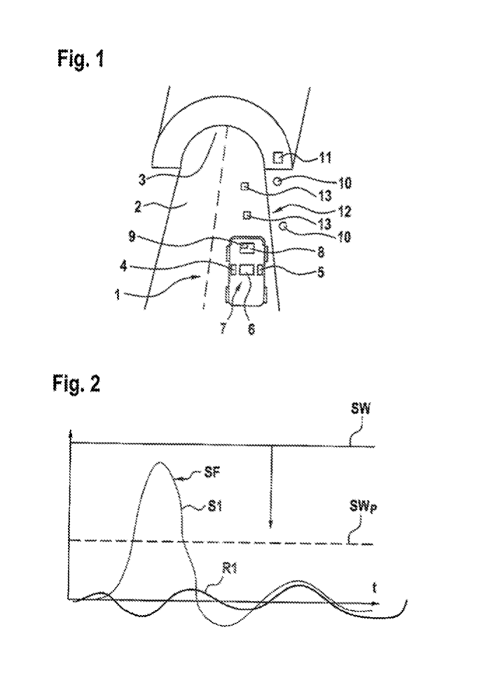

FIG. 1 shows a simplified illustration of a vehicle 1 which is moving along a roadway 2. According to the present exemplary embodiment, the roadway 2 leads here into a tunnel 3.

The vehicle 1, which as a motor vehicle has an electrical drive device or a drive device in the form of an internal combustion engine is also provided with a plurality of sensors 4, 5 which during the ongoing driving mode of the vehicle 1 detect operational values which are evaluated or used to increase the comfort or the driving safety of the vehicle 1. In this way, for example the sensor 4 detects, as an acceleration sensor, lateral forces which act on the vehicle 1, in order to initiate safety braking when required, and the sensor 5 detects the brightness of the ambient light, as a function of which a headlight device and/or interior lighting of the vehicle 1 are/is actuated.

The output signals of the sensors 4, 5 are compared, in particular by means of a comparison with predefinable threshold values by one or more control units 6, in order to be able to decide about the control of the headlight device or, for example, a brake device when excessively high lateral forces occur. In particular, the output signals are evaluated by a central control unit 6, for example an ESP control unit. Alternatively it is possible to provide that at least some of the output signals are evaluated by control units of the sensors 4, 5 themselves. The sensors 4, 5 form in this respect, together with the control unit 6 a sensor apparatus 7 of the motor vehicle.

The sensor apparatus 7 also has a checking device 8 which is designed to monitor the functional capability of the sensors 4, 5, with the result that incorrect triggering or faulty failure to trigger can be avoided in that, for example, a system for which the respective sensor 4, 5 supplies a calculation value is switched to a safe state.

The checking device 8 has a communication device 9 which is designed to detect reference means in the surroundings of the vehicle. According to one exemplary embodiment there is provision that the communication device 9 is embodied as a camera device which monitors the surroundings visually for reference means.

According to the present exemplary embodiment there is provision that visual marks 10 are arranged spaced apart from one another in the direction of travel as reference means on the edge of the road in such a way that they can be detected visually by the camera device or the communication device 9. The marks 10 define or delimit a reference section along which the vehicle 1 moves during the further driving. As soon as the vehicle 1 passes the first reference means or the first mark 10, and the latter is detected by the camera device, a checking process for one or both of the sensors 4, 5 is started, during which process the output signals of the sensors 4 and/or 5 are compared with a respective setpoint output signal.

FIG. 2 shows in this respect the signal profile S1 of the output signal of the sensor 4 plotted against the time T in a diagram. During normal operation, the output signal of the sensor 4 is compared with the threshold value SW. If the output signal S1 exceeds the threshold value SW, a fault is identified. In order to be able to take into account, in particular, external influences during the threshold value comparison while driving, with the result that said influences do not immediately bring about a triggering result, if the threshold value SW is set to a correspondingly high value, in order to avoid detecting a fault whenever the output signal increases.

As soon as the vehicle 1 has detected the first mark 10 by means of the communication device 9, the threshold value SW is reduced to a lower checking threshold value SW_{P} for the purpose of checking, as shown by a dashed line in FIG. 2. The sensor 4 has therefore been switched to a more sensitive setting for the checking process described below.

With the detection of the first mark 10, a comparison of the output signal S1 with a reference signal R1 starts, said reference signal R1 representing a setpoint output signal of the sensor 4 which should be generated when the reference section following the first mark 10 is travelled along by the sensor 4. The setpoint output signal is loaded here, for example, from a non-volatile memory of the sensor 4 or of the control unit 6 when the first mark 10 is detected. It is also conceivable that the setpoint output signal is selected as a function of the detected mark 10 or the detected reference means from a characteristic field, in order to obtain a setpoint output signal which is suitable for the application. During the comparison, the output signal S1 is compared with the reference signal R1 and checked for deviations. If the output signal S1 differs from the setpoint output signal over a predetermined value or range, it is identified that the sensor 4 has a fault or defect.

In the present case, the first mark 10 is followed by a straight roadway section, with the result that no lateral accelerations which could lead to a deflection of the output signal should act on the sensor 4. However, in the exemplary embodiment shown in FIG. 2 the output signal S1 has a sensor fault SF which cannot be caused by external influences owing to the straight section of road. The setpoint output signal corresponds to the expected output signal of the sensor during the straight-ahead travel. The comparison of the output signal S1 with the reference signal R1 is therefore informative with respect to the functional capability of the sensor 4 during the travel along the known reference section.

The comparison is preferably carried out with the detection of the first mark 10 for a predetermined time or a predetermined distance. As an alternative the comparison is ended when a second mark 10 is detected by means of the communication device 9. The reference section is therefore defined by the reference means or the marks 10 themselves.

As an alternative to the detection of visual marks 10 at the edge of the roadway it is, for example, also possible to detect a visual mark 11 such as is provided at the input of the tunnel 3. Therefore, for example the output signal of the sensor 5 can, for the purpose of detecting the ambient brightness, be compared with a setpoint output signal which should be waited for when traveling through a tunnel.

Furthermore, it is conceivable for the communication device 9 to have a radio module which can communicate with a stationary communication device 12 when travelling past, for example by WLAN or some other close-range radio technology. By means of the communication between the radio module and the stationary communication device 12 it is possible for data to be transmitted both from the vehicle 1 to the communication device 12 and vice versa. As a result, it can for example be ensured that the communication device 9 detects the communication device 12 and interrogates one or more setpoint output signals for the subsequent reference section, which is then sent by the communication module 12 to the communication device 9, where they are used for the following comparison. Alternatively, the communication serves merely for starting and ending the comparison or for characterizing the start and/or end of the reference section.

It is also possible to provide that magnetic or else electromagnetic markings 13, over which the vehicle 1 is moved when traveling straight ahead, are inserted into the roadway. The communication device 9 correspondingly has a magnetosensitive module for detecting the markings 13. The first marking 13 defines the start and the second marking 13 defines the end of the reference section. During the comparison of the output signal with the setpoint output signal the procedure here is as described above.

The checking of the sensor 5 is expediently performed in a corresponding way by the checking device 8.

By means of the advantageous method and the advantageous checking apparatus it is ensured that the vehicle is informed that it is on a section of road which is defined as a reference section or can be used as a reference section. These are, in particular, parts of a section of a freeway without damage or other road works or incidents. An example would also be travel through a tunnel or straight-ahead travel, as described above. Basically, the communication with the surroundings can be carried out visually by means of the detection of a specific code or mark 10 at the edge of the road and/or in the center of the roadway or next to the roadway 2 by means of the camera device or the radio module or the magnetosensitive module. The sensors on the reference section must each generate an output signal which lies within predefinable limits or within a predefinable threshold value SW with respect to a setpoint output signal. Therefore, for the comparison the threshold value SW which is used during normal operation is reduced to the checking threshold value SW_{P} as already described, said checking threshold value SW_{P} being dependent on the setpoint output signal, with the result that it is not exceeded by the setpoint output signal. If the actual output signal S1 then exceeds the checking threshold value SW_{P}, a fault of the respective sensor 4, 5 is inferred. The knowledge about the reference section which, by means of the communication device which ultimately constitutes a vehicle-to-X interface, permits it to switch the fault detection limits to a more sensitive setting while driving along the reference section, such as, for example, by adapting the threshold value SW to the checking threshold value SW_{P}. When the comparison ends, the checking threshold value SW_{P} is switched back to the normal value SW and the sensor is therefore switched to a robust setting as soon as the reference section has been passed through.

The core of the method is therefore the detection of sensor faults by reprogramming or adapting a fault detection function by means of the control unit 6, or alternatively in the sensors 4,5 themselves, during travel on the reference section, which is detected by the communication device 9. This approach permits a relatively large class of faults to be detected in a short time by virtue of the fact that a current driving state is taken into account during the checking of a sensor. By virtue of the communication device 12, the detection takes place during driving, with the result that checking can be carried out regularly or when necessary. The start or the end of a reference section is preferably communicated to all the control units of the vehicle for example via a BUS, with the result that said control units can always adapt their checking strategies.

If a sensor fault is detected during the checking, the sensor 4, 5 or a system which uses the sensor is preferably deactivated or switched to a safe state. Additionally or alternatively, an entry is made in a control unit 6 so that at the next visit to a workshop the control unit 6 and/or the sensor 4, 5 can be checked more precisely. A warning lamp for the driver of the vehicle 1 can also be actuated as a result of the fault detection.

What is claimed is:

1. A sensor apparatus for a vehicle, the sensor apparatus comprising:
at least one sensor configured to detect operational values of the vehicle while driving on a roadway; and
a checking device configured to monitor a functional capability of the at least one sensor, the checking device including:
at least one communication device configured to detect a reference in a surroundings of the vehicle during driving; and
a control unit configured to determine the functional capability of the at least one sensor by comparing an output signal of the at least one sensor with an expected setpoint output signal as a function of the detected reference.

2. The sensor apparatus according to claim 1, the at least one communication device comprising:
at least one camera device configured to optically detect at least one visual mark as the reference in the surroundings of the vehicle.

3. The sensor apparatus according to claim 1, the at least one communication device comprising:
at least one radio module configured to wirelessly communicate with at least one stationary communication device as the reference in the surroundings of the vehicle.

4. The sensor apparatus according to claim 1, the at least one communication device comprising:
at least one magnetosensitive sensor module configured to interact with at least one of (i) at least one magnetic marking and (ii) at least one electrical marking as the reference in the surroundings of the vehicle.

5. A vehicle comprising:
a sensor apparatus comprising:
at least one sensor configured to detect operational values of the vehicle while driving on a roadway; and
a checking device configured to monitor a functional capability of the at least one sensor, the checking device including:
at least one communication device configured to detect a reference in a surroundings of the vehicle during driving; and
a control unit configured to determine the functional capability of the at least one sensor by comparing an output signal of the at least one sensor with an expected setpoint output signal as a function of the detected reference.

6. A method for operating a sensor apparatus for a vehicle, the method comprising:
detecting, with at least one sensor of the sensor apparatus, operational values of the vehicle while driving on a roadway; and
monitoring, with a checking device of the sensor apparatus, a functional capability of the at least one sensor, the monitoring comprising:
detecting, with at least one communication device of the checking device, a reference in a surroundings of the vehicle during driving; and
determining, with a control unit of the checking device, the functional capability of the at least one sensor by comparing an output signal of the at least one sensor with an expected setpoint output signal as a function of the detected reference.

7. The method according to claim 6, the detecting of the reference in the surroundings of the vehicle further comprising:
detecting the reference with at least one of (i) at least one camera device of the at least one communication device, (ii) at least one radio module of the at least one communication device, and (iii) at least one magnetosensitive sensor module of the at least one communication device.

8. The method according to claim 6, the determining of the functional capability further comprising:
starting the comparing of the output signal with the expected setpoint output signal in response to a first reference being detected; and
ending the comparing of the output signal with the expected setpoint output signal in response to a subsequent second reference being detected.

9. The method according to claim 6, the determining of the functional capability further comprising:
increasing a sensitivity of the at least one sensor during the comparing of the output signal with the expected setpoint output signal.

10. The method according to claim 6, the detecting of the reference in the surroundings of the vehicle further comprising:
detecting as the reference at least one of (i) a visual mark, (ii) a stationary communication device; (iii) a magnetic marking; and (iv) electrical marking, the reference being at least one of on and next to the roadway.

11. The sensor apparatus according to claim 1, wherein the vehicle is a motor vehicle.

12. The vehicle according to claim 5, wherein the vehicle is a motor vehicle.

13. The method according to claim 6, wherein the vehicle is a motor vehicle.

14. The method according to claim 9, the increasing of the sensitivity of the at least one sensor further comprising:
reducing a triggering threshold value as a function of the expected setpoint output signal.
